(19) United States
(12) Patent Application Publication
(10) Pub. No.: US 2009/0298023 A1
(43) Pub. Date: Dec. 3, 2009

(54) Electrical Components and Bread-Board for Electrical Circuit Study Kit

(76) Inventors: Kyung-Keun Kim, Seoul (KR); Dong-Kyun Lim, Kyeonggi-Do (KR); In-Suk Han, Sandy, UT (US)

Correspondence Address: THORPE NORTH & WESTERN, LLP., P.O. Box 1219, SANDY, UT, 84091-1219, US

(21) Appl. No.: 12/087,181

(22) PCT Filed: Sep. 15, 2006
(86) PCT No.: PCT/KR2006/003696

§ 371 Date: Jan. 22, 2009

(30) Foreign Application Priority Data
Dec. 28, 2005 (KR) 10-2005-0131597

(51) Int. Cl. G09B 19/00

(52) U.S. Cl. 434/224

(57) ABSTRACT

Provided are electrical components and a breadboard for an electronic circuit study kit. The breadboard includes: a base formed of a metallic material to a predetermined width so that an electronic circuit kit can be attached to the base by a magnetic force; an interconnection sheet which is disposed on an upper portion of the base and in which a plurality of power pads for electric short and a plurality of ground pads which are adjacent to one another on its upper surface, are formed to be spaced apart from one another from one side direction to the other side direction on a plane, the power pads and the ground pads are connected to power terminal pads and ground terminal pads which are formed in predetermined positions of an upper surface of the interconnection sheet, respectively, a plurality of interconnection pads are formed between one power pad and one ground pad which are adjacent to each other from another power pad and another ground pad which are adjacent to each other, to be spaced apart from one another in a predetermined pattern, the interconnection sheet being formed of one of a thin plate and a film sheet made of an insulating material; a circuit board which is disposed on an upper portion of the interconnection sheet and in which terminal holes are respectively formed in corresponding positions of the power terminal pads and the ground terminal pads of the interconnection sheet and a plurality of circuit connection holes are perforated by a predetermined distance so that the circuit connection holes can be located on vertical upper portions of the power pads, the ground pads and the interconnection pads of the interconnection sheet; an insulating plate disposed on a lower portion of the base and formed of an insulating material; and a combining means of the circuit board allowing the base to be combined with an upper portion of the insulating plate, the interconnection sheet to be combined with an upper portion of the base and the circuit board to be disposed and fixed on an upper portion of the interconnection sheet.

### TECHNICAL FIELD

The present invention relates to electrical components and a breadboard for an electronic circuit study kit, and more particularly, to electrical components and a breadboard for an electronic circuit study kit in which soldering works and injury factors of human life caused by the soldering works when an electronic circuit is configured to be used for a study or test can be excluded, the operation of an electronic circuit can be easily understood by logic symbols indicated on its upper portion, damages are prevented even when electrical components are repeatedly attached or detached so that the electrical components can be repeatedly used and a waste of resources can be minimized.

### BACKGROUND ART

In order to manufacture an electronic circuit for study, a measuring device such as a tester or an oscilloscope, a soldering device, a solder, electric wires (conducting wires), a nipper, a substrate, a solder inhaler, an electrical material such as a breadboard 1 illustrated in FIG. 1, and electrical elements such as a manufacturing tool, a resistor, a condenser, a semiconductor integrated circuit (IC), and a diode should be provided.

Such electrical equipment for study, material and electrical components are not produced only for study. In actuality, they are produced to be actually used in a job site, are purchased by schools or institutes and an individual and then are used for study.

In general, in order to configure a desired system and circuit using various kinds of electrical components, several factors for determining characteristics of the system are defined as elements which generally indicate the factors, and a circuit diagram is made up, as illustrated in FIG. 2, so that the elements are connected to one circuit and desired functions can be performed.

If the circuit diagram is made up as described above, each of the elements is inserted in a pin hole 2 of the breadboard 1 illustrated in FIG. 1 according to the circuit diagram and then, a circuit is completed using jump lines so that the circuit can be configured as illustrated in the circuit diagram.

Here, a skilled person who can use the breadboard 1 well or has special knowledge and function about circuits, can simply configure a simple circuit illustrated in FIG. 2 in the breadboard 1 as the shape of the circuit diagram. On the other hand, it is difficult for an unskilled person or a student who learns circuits to effectively utilize the breadboard 1 and to configure a circuit in the breadboard 1 as the shape of the circuit diagram.

A difference between ability for configuring the circuit as the shape of the circuit diagram and inability for configuration the circuit as the shape of the circuit diagram as described above depends on whether how fast a disparate concept between theory and practice is overcome by eliminating and complementing factors by easily detecting factors that affect characteristics of a circuit such as internal resistance of the circuit and internal resistance according to blocks even when the circuit performs or does not perform a desired function after the circuit is configured.

That is, when the circuit is configured according to the circuit diagram, how to set the criterion of a current direction, how to promise polarities of a voltage applied to each element, what characteristics of the circuit are when voltage and current sources of the circuit are completely eliminated, and characteristics of the circuit caused by the voltage and current sources should be known.

However, the above-described conventional breadboard 1 has the state of a pin block 3 in which about five pin holes 2 in which elements are to be inserted are connected to one another when the circuit is configured, as illustrated in FIG. 1. Thus, a plurality of pin blocks 3 are arranged in a lengthwise direction and are connected to one another in a widthwise direction, whereas a pin block 3a and a pin block 3b in the lengthwise direction are disconnected from each other.

Thus, the arrangement of elements of the circuit may be the same in both the widthwise and lengthwise directions. On the other hand, five pin holes are connected to one another in the widthwise direction but are disconnected from one another in the lengthwise direction. Thus, when the circuit is configured in the lengthwise direction, jump lines should be always used. Thus, it is very difficult to configure the circuit as the shape of the circuit diagram. As the number of jump lines increases, the probability that errors may occur in configuration is high and the circuit is complicated. Thus, there is a drawback that circuit analysis is very difficult.

### DISCLOSURE OF THE INVENTION

The present invention provides electrical components and a breadboard for an electronic circuit study kit in which a circuit can be more conveniently configured and simultaneously, the circuit can be identified by naked eyes to correct errors and damages are prevented even when electrical components are repeatedly attached or detached so that the electrical components can be used for a long time.

According to an aspect of the present invention, there is provided a breadboard for an electronic circuit study kit, the breadboard including: an interconnection sheet in which a plurality of power pads for electric short and a plurality of ground pads which are adjacent to one another, are formed to be spaced apart from one another from one side direction to the other side direction on a plane, the power pads and the ground pads are connected to power terminal pads and ground terminal pads which are formed in predetermined positions of an upper surface of the interconnection sheet, respectively, a plurality of interconnection pads are formed between one power pad and one ground pad which are adjacent to each other from another power pad and another ground pad which are adjacent to each other, to be spaced apart from one another in a predetermined pattern, the interconnection sheet being formed of one of a thin plate and a film sheet made of an insulating material; a base combined with a lower portion of the interconnection sheet and formed of a metallic material to a predetermined width so that an electronic circuit kit can be attached to the base by a magnetic force; and a combining means of an interconnection sheet for combining the interconnection sheet with the base.

The combining means of the interconnection sheet may include: a plurality of combining holes perforated in predetermined positions of the interconnection sheet; a plurality of first screw holes formed in predetermined positions of the base corresponding to the combining holes; and a first fixing screw perforated into the combining holes and screw-coupled to the first screw holes.

The breadboard may further include an insulating plate disposed on a lower portion of the base and formed of an insulating material in which a second screw hole is formed so that the second screw hole can be combined with a first fixing screw that is screw-coupled to a first screw hole and protrudes.

According to another aspect of the present invention, there is provided a breadboard for an electronic circuit study kit, the breadboard including: a base formed of a metallic material to a predetermined width so that an electronic circuit kit can be attached to the base by a magnetic force; an interconnection sheet which is disposed on an upper portion of the base and in which a plurality of power pads for electric short and a plurality of ground pads which are adjacent to one another on its upper surface, are formed to be spaced apart from one another from one side direction to the other side direction on a plane, the power pads and the ground pads are connected to power terminal pads and ground terminal pads which are formed in predetermined positions of an upper surface of the interconnection sheet, respectively, a plurality of interconnection pads are formed between one power pad and one ground pad which are adjacent to each other from another power pad and another ground pad which are adjacent to each other, to be spaced apart from one another in a predetermined pattern, the interconnection sheet being formed of one of a thin plate and a film sheet made of an insulating material; a circuit board which is disposed on an upper portion of the interconnection sheet and in which terminal holes are respectively formed in corresponding positions of the power terminal pads and the ground terminal pads of the interconnection sheet and a plurality of circuit connection holes are perforated by a predetermined distance so that the circuit connection holes can be located on vertical upper portions of the power pads, the ground pads and the interconnection pads of the interconnection sheet; an insulating plate disposed on a lower portion of the base and formed of an insulating material; and a combining means of the circuit board allowing the base to be combined with an upper portion of the insulating plate, the interconnection sheet to be combined with an upper portion of the base and the circuit board to be disposed and fixed on an upper portion of the interconnection sheet.

The combining means of the circuit board may include: a plurality of first through holes formed in the insulating plate; a plurality of second through holes formed in the base to correspond to the first through holes; a plurality of third through holes formed in the base to correspond to the second through holes; a third screw hole formed to protrude from a bottom surface of the circuit board to correspond to the third through holes; and a second fixing screw perforating the first through holes, the second through holes, and the third through holes and screw-coupled to the third screw hole.

According to another aspect of the present invention, there is provided electrical components for an electronic circuit study kit, the electrical components including: electric short connection holes which are perforated in an upper portion of a substrate in an arrangement pattern corresponding to terminal pin arrangement so that terminal pins of a predetermined electrical element can be inserted and combined in the electric short connection holes and in which a pad for electric short is formed on at least one of upper and lower ends of the electric short connection holes; electric short combination holes which are perforated to a number corresponding to the number of electric short connection holes in at least one of frames of an upper surface of the substrate and in which a pad for electric short is formed on at least one of upper and lower ends of the electric short combination holes; pad leads for electric short which are connected to a pad of the electric short connection hole and a pad of the electric short combination hole, respectively, so that the pad of the electric short connection hole and the pad of the electric short combination hole can correspond to each other and can be electric shorted and which are formed on at least one of an upper portion and a lower portion of the substrate; and an electronic circuit kit electric short portion inserted and combined to be perforated in the electric short combination holes and formed to a predetermined length having a magnetic force.

According to another aspect of the present invention, there is provided electrical components for an electronic circuit study kit, the electrical components including: electric short connection holes which are perforated in an upper portion of a substrate in an arrangement pattern corresponding to terminal pin arrangement so that terminal pins of a predetermined electrical element can be inserted and combined in the electric short connection holes and in which a pad for electric short is formed on at least one of upper and lower ends of the electric short connection holes; electric short combination holes which are perforated to a number corresponding to the number of electric short connection holes in at least one of frames of an upper surface of the substrate and in which a pad for electric short is formed on at least one of upper and lower ends of the electric short combination holes; pad leads for electric short which are connected to a pad of the electric short connection hole and a pad of the electric short combination hole, respectively, so that the pad of the electric short connection hole and the pad of the electric short combination hole can correspond to each other and can be electric shorted and which are formed on at least one of an upper portion and a lower portion of the substrate; an electronic circuit kit electric short portion inserted and combined to be perforated in the electric short combination holes and formed to a predetermined length having a magnetic force; a lower case in which at least one or more electric short holes correspond to the electric short connection holes so that the electronic circuit kit electric short portion to be inserted and combined in the electric short connection holes can be perforated in a downward direction; an upper case combined with an upper portion of the lower case and embedded in the electrical components so that the substrate can be hidden; and a combining means of a case for combining the upper case with the lower case.

The combining means of the case may include: one of a hook and a hook groove formed in a predetermined position of an outer end of the lower case; and one of a hook groove and a hook corresponding to the hook or the hook groove formed in a predetermined position of a lower inner side surface of the upper case inserted in the outer end of the lower case.

The combining means of the case may include: a guide groove formed on both lower inner side surfaces of the upper case in a lengthwise direction so that both ends of the lower case can be inserted and guided in the guide groove; a fixing protrusion protruding in a predetermined position of both ends of the lower case; and a fixing groove formed in the guide groove to correspond to the fixing protrusion.

The combining means of the case may include: a plurality of fourth screw holes protruding from a bottom surface of the upper case in a downward direction; fourth through holes formed in the lower case to correspond to the fourth screw holes; and a third fixing screw perforated into the fourth through holes and screw-coupled to the fourth screw holes.

The electrical components may further include a pressing portion protruding in a predetermined position of an inner bottom surface of the upper case toward a downward direction and pressing the substrate in the downward direction.

### BRIEF DESCRIPTION OF THE DRAWINGS

FIG. 1 is an appearance perspective view of an appearance of a conventional breadboard.

FIG. 2 illustrates a circuit for study.

FIG. 3 is an exploded perspective view of a breadboard for an electronic circuit study kit according to the present invention.

FIG. 4 is an exploded perspective view of a breadboard for an electronic circuit study kit according to an embodiment of the present invention.

FIG. 5 illustrates an interconnection sheet according to the present invention.

FIG. 6 is an exploded perspective view illustrating the configuration of electrical components for an electronic circuit study kit according to the present invention.

FIG. 7 is an exploded perspective view of electrical components for an electronic circuit study kit according to an embodiment of the present invention.

FIG. 8A illustrates an embodiment of an upper and lower case combining structure of the electrical components for an electronic circuit study kit illustrated in FIG. 7.

FIG. 8B illustrates another embodiment of an upper and lower case combining structure of the electrical components for an electronic circuit study kit illustrated in FIG. 7.

FIG. 8C illustrates another embodiment of an upper and lower case combining structure of the electrical components for an electronic circuit study kit illustrated in FIG. 7.

FIG. 9 illustrates the state where the circuit of FIG. 2 is configured in a breadboard for an electronic circuit study kit using electrical components for an electronic circuit study kit according to the present invention.

FIG. 10 illustrates a breadboard for an electronic circuit study kit according to another embodiment of the present invention.

FIG. 11 illustrates the state where a resistor is configured using electrical components for an electronic circuit study kit according to the present invention.

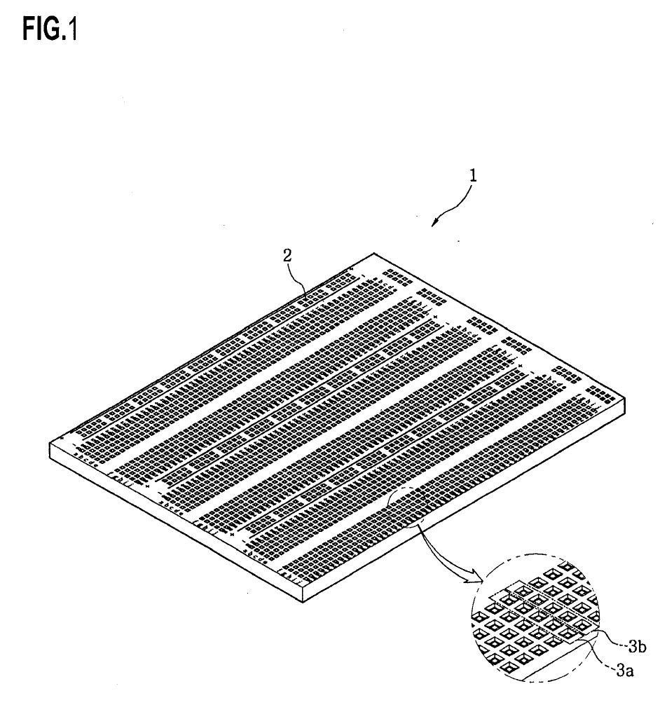

### BEST MODE FOR CARRYING OUT THE INVENTION

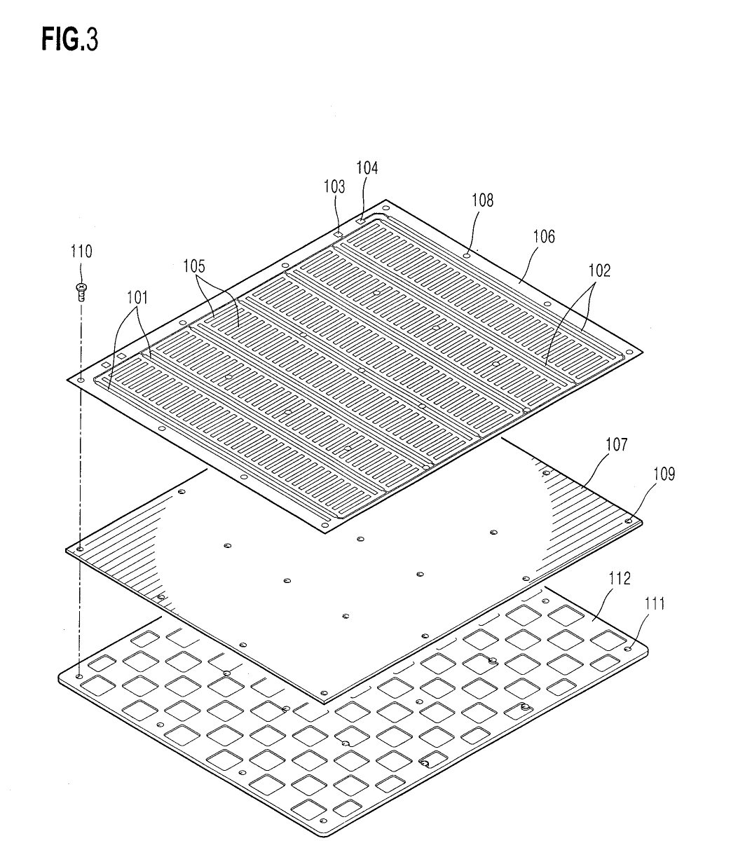

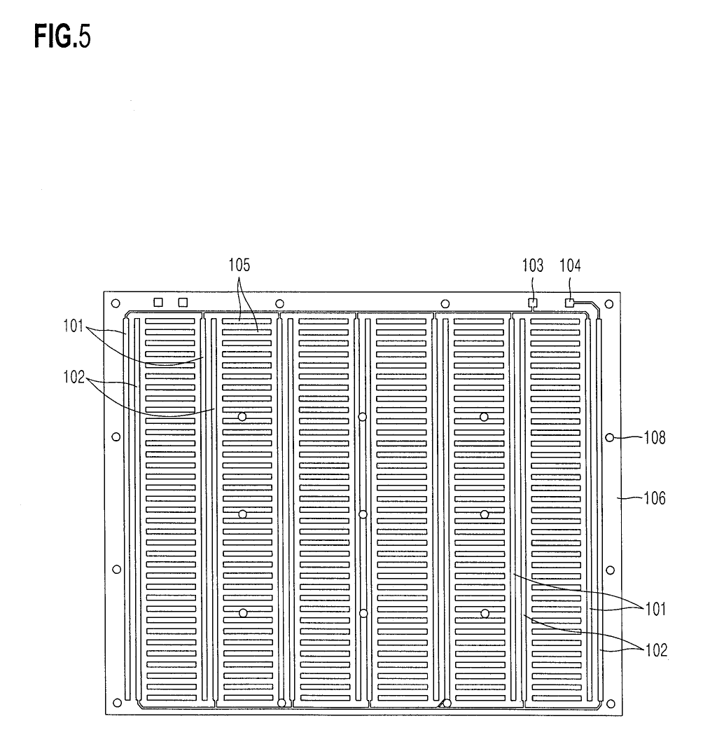

Hereinafter, configuration and operation of the present invention will be described with reference to FIGS. 3 through 11.

First, it is preferable that a breadboard for an electronic circuit study kit according to the present invention is manufactured in the same pattern as that of a pin block of a conventional breadboard so that study, full knowledge and practical use of the breadboard can be easily made.

That is, it is preferable that an interconnection sheet 106 is formed of a thin plate or film sheet made of an insulating material and a power terminal pad 103 for electric short, a ground terminal pad 104, a power pad 101, a ground pad 102, and an interconnection pad 105 are manufactured on an upper surface of the interconnection sheet 106 in the same pattern as that of the conventional breadboard.

Thus, the power terminal pad 103 to which an external power is to be connected, and the ground terminal pad 104 for ground are formed (or printed) in predetermined positions of frames of an upper surface of the interconnection sheet 106, as illustrated in FIG. 3.

The power pad 101 to be connected to the power terminal pad 103 and the ground pad 102 to be connected to the ground terminal pad 104 are adjacent to each other so that the power pad 101 and the ground pad 102 form a pair, and the power pad 101 and the ground pad 102 extend in a lengthwise direction from the interconnection sheet 106 to a predetermined length.

As described above, a plurality of power pads 101 and a plurality of ground pads 102 each of which form a pair, are formed to be spaced apart from one another by a predetermined distance, as illustrated in FIGS. 3, 4, and 5.

Furthermore, a plurality of interconnection pads 105 are formed between respective pair of power pads 101 and ground pads 102, and are spaced apart from one another by a predetermined distance in the lengthwise direction.

The power pads 101, the ground pads 102, and the interconnection pads 105 may be spaced apart from one another by a predetermined distance, as illustrated in FIG. 3 through FIG. 5.

A base 107 formed of a metallic material so that an electronic circuit study kit can be attached to a lower portion of the interconnection sheet 106 by a magnetic force, and the base 107 and the interconnection sheet 106 are combined with each other so that a breadboard for an electronic circuit study kit can be configured.

In a combining means for combining the base 107 with the interconnection sheet 106 according to the present invention, a plurality of combining holes 108 are perforated in the interconnection sheet 106, as illustrated in FIG. 3, a first screw hole 109 is formed in the base 107 to correspond to the combining holes 108, and a first fixing screw 110 perforates the combining holes 108 to be screw-coupled to the first screw hole 109 so that the base 107 and the interconnection sheet 106 can be combined with each other.

Furthermore, considering that a breadboard is used to study or test characteristics and configuration of a circuit, it is preferable that a second screw hole 111 is formed to correspond to the first screw hole 109, an insulating plate 112 made of an insulating material is disposed on a lower portion of the base 107, and the second screw hole 111 is screw-coupled to the first fixing screw 110 screw-coupled to the first screw hole 109 and perforated so that use safety and damages of a product can be prevented.

As described above, the combining means of the interconnection sheet is suggested as one embodiment and the present invention is not limited to this and may adopt various methods and means.

That is, the objective of the present invention can be achieved even when the base 107 and the interconnection sheet 106 are attached to each other by applying an adhesive to an upper surface of the base 107 or to a bottom surface of the interconnection sheet 106. This combining means may be adopted by one of ordinary skill in the art in various shapes and thus will not be restricted.

Furthermore, the interconnection sheet 106 may be a hard board of a thin plate made of an insulating material, or a film sheet. However, the thickness of the interconnection sheet 106 at which a magnetic force of an electronic circuit kit electric short portion 126 which is electrical components for an electronic circuit study kit which will be described later allows the interconnection sheet 106 to be perforated and the electronic circuit kit electric short portion 126 is attached to the base 107 should be guaranteed.

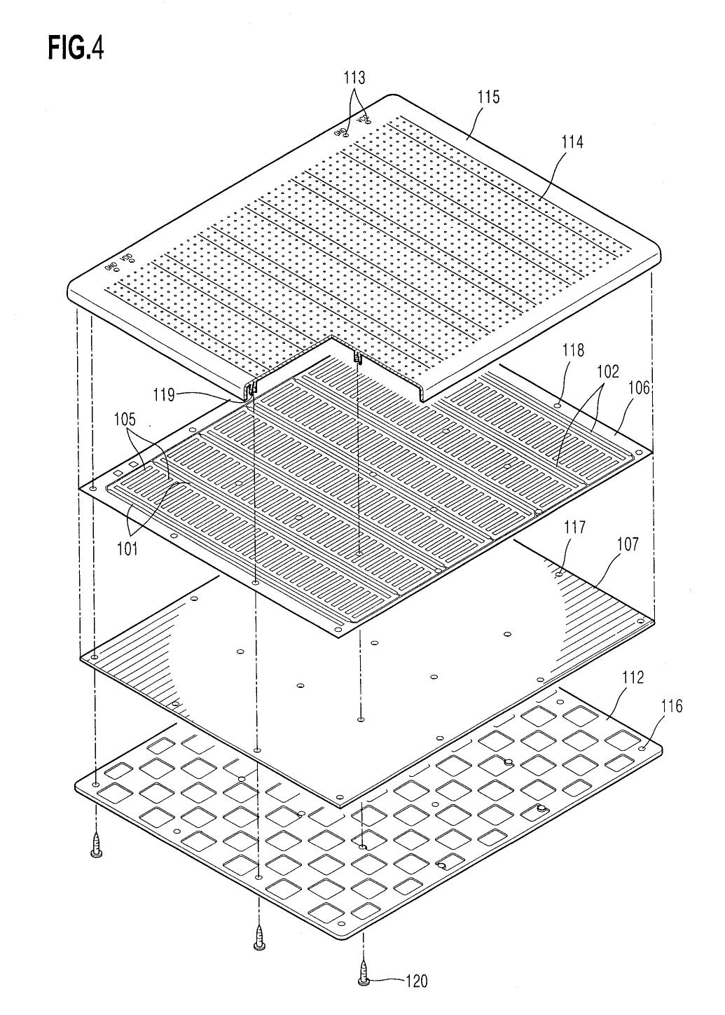

A breadboard for an electronic circuit study kit according to an embodiment of the present invention will now be described with reference to FIG. 4.

That is, the objective of the present invention is achieved by disposing a circuit board 115 on an upper portion of the base 107 and by disposing an insulating plate 112 on a lower portion of the base 107 so that the insulating plate 112, the base 107, the interconnection sheet 106, and the circuit board 115 can be combined with one another using a combining means of the circuit board 115.

Here, the circuit board 115 is disposed on an upper portion of the interconnection sheet 106, terminal holes 113 corresponding to the power terminal pad 103 and the ground terminal pad 104 of the interconnection sheet 106 are formed, and a plurality of circuit connection holes 114 are perforated by a predetermined distance so that the circuit connection holes 114 can be located on vertical upper portions of the power pad 101, the ground pad 102 and the interconnection pad 105 of the interconnection sheet 106.

Furthermore, in a combining means for combining the insulating plate 112, the base 107, the interconnection sheet 106, and the circuit board 115 with one another according to the present invention, a plurality of first through holes 116 are formed in the insulating plate 112, a plurality of second through holes 117 are formed in the base 107 to correspond to the first through holes 116, and a plurality of third through holes 118 are formed in the interconnection sheet 106 to correspond to the second through holes 117.

A third screw hole 119 is formed to protrude from a bottom surface of the circuit board 115 to correspond to the first through holes 116, the second through holes 117, and the third through holes 118, as illustrated in FIG. 4. The base 107 is disposed on an upper portion of the insulating plate 112, the interconnection sheet 106 is disposed on an upper portion of the base 107, and the circuit board 115 is disposed on the upper portion of the interconnection sheet 106, as illustrated in FIG. 4.

Thus, the second fixing screw 120 perforates the first through holes 116, the second through holes 117, and the third through holes 118 to be screw-coupled to the third screw hole 119 so that the insulating plate 112, the base 107, the interconnection sheet 106, and the circuit board 115 can be combined with one another as one body.

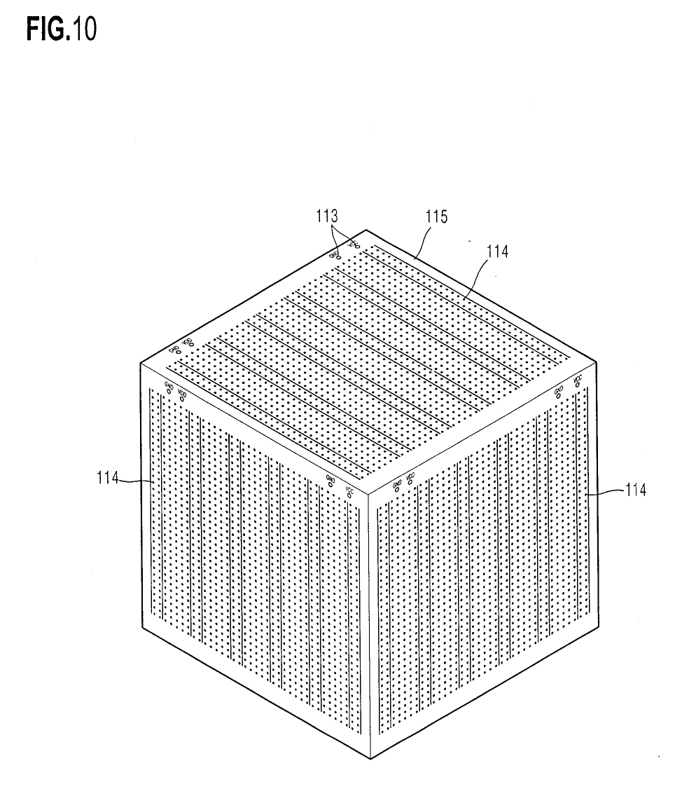

Here, the shape of the breadboard for an electronic circuit study kit according to the present invention is not limited to a planar shape described in the attached drawings and in the detailed description and may be rectangular parallelepiped illustrated in FIG. 10 or may be manufactured in various shapes such as an elliptical shape and a curved surface. The above shapes may be implemented through various creations and thus will be considered to be included in a technical solution for achieving the objective of the present invention.

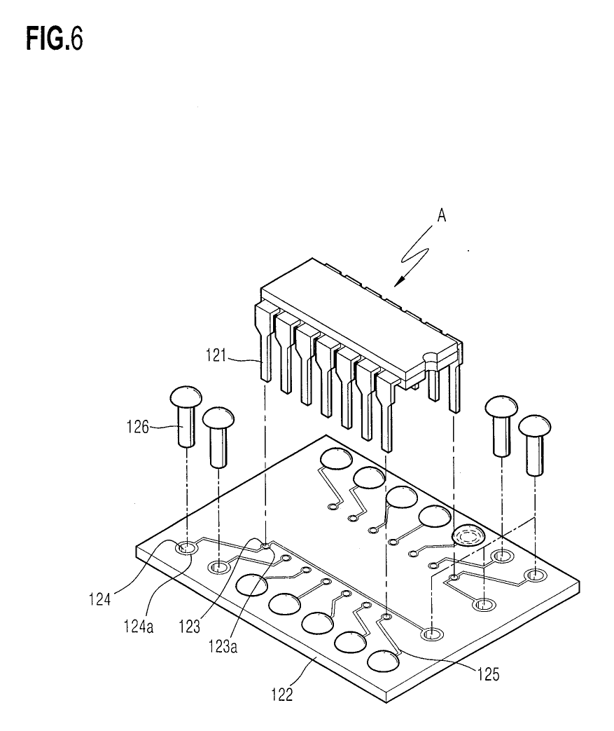

Electrical components for an electronic circuit study kit used to configure a circuit in the breadboard for an electronic circuit study kit according to the present invention will now be described with reference to FIG. 6.

As illustrated in FIG. 6, in the electrical components for an electronic circuit study kit according to the present invention, an electric short connection hole 123 is perforated in a substrate 122 so that a terminal pin 121 for electrical elements such as an IC, a resistor, and a condenser can be inserted and combined in the electric short connection hole 123 and can be electric shorted.

Here, the electric short connection hole 123 is performed in an arrangement pattern corresponding to the arrangement of the terminal pin 121, and a pad 123a for electric short is formed on at least one of upper and lower ends of the electric short connection hole 123.

Furthermore, a plurality of electric short combination holes 124 are performed in at least one portion of frames of an upper surface of the substrate 122 to correspond to the electric short connection hole 123, and a pad 124a for electric short is formed in at least one of upper and lower ends of the electric short combination holes 124.

A pad 123a of the electric short connection hole 123 and a pad 124a of the electric short-combination hole 124 are connected to a pad lead for electric short 125, as illustrated in FIG. 6, so that the pad 123a of the electric short connection hole 123 and the pad 124a of the electric short combination hole 124 can correspond to each other and can be electric shorted.

Thus, as illustrated in FIG. 6, if an electronic circuit kit electric short portion 126 formed to a predetermined length having a magnetic force is forcibly inserted and combined in the electric short combination hole 124, the electronic circuit kit electric short portion 126 can be electrically connected to the terminal pin 121 of electrical elements using the pad 123a of the electric short connection hole 123, the pad lead 125, and the pad 124a of the electric short combination hole 124.

Here, the electronic circuit kit electric short portion 126 may be inserted in the electric short combination hole 124 and then, the electronic circuit kit electric short portion 126 and the electric short combination hole 124 may be combined with each other using an adhesive.

In addition, the electronic circuit kit electric short portion 126 and the electric short combination hole 124 may also be combined with each other by forming a male screw in the electronic circuit kit electric short portion 126, by forming a female screw in the electric short combination hole 124, and by screw-coupling the male screw and the female screw.

Thus, the present invention may adopt and change various methods including the above-described method and thus will not be limited to this.

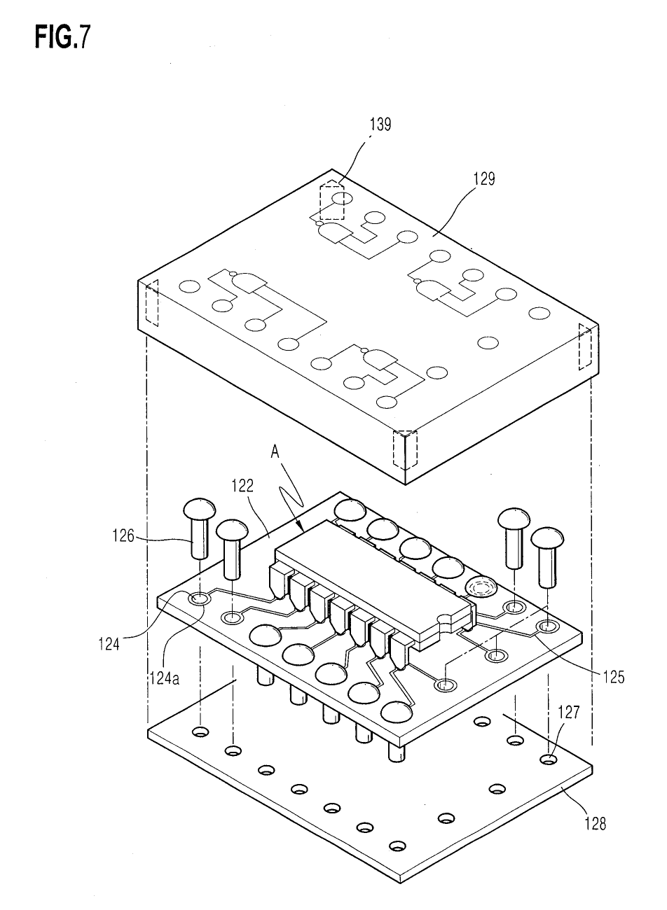

An electronic element A (74LS00) illustrated in FIGS. 6 and 7 is an element comprised of 4 NAND gates including two input terminals and one output terminal. As illustrated in FIGS. 6 and 7, an electric short connection hole 123 is performed in an upper portion of the substrate 122 to correspond to the terminal pin 121 of 74LS00, and a plurality of electric short combination holes 124 are perforated in the vicinity of an outer frame of the substrate 122 to correspond to the number of electric short connection holes 123.

Electrical components for an electronic circuit study kit according to an embodiment of the present invention will now be described with reference to FIG. 7 through FIG. 11.

The embodiment illustrates the description of embedded electrical components on an upper surface in which electrical components are embedded and simultaneously, the embedded electrical components can be easily identified and used by a learner or a user so that electrical components described with reference to FIG. 6 can be hidden and protected.

In other words, the electronic circuit kit electric short portion 126 that protrudes in a downward direction from a lower portion of the substrate 122 of electrical components in which the electronic element terminal pin 121 is inserted and combined in the electric short connection hole 123 of the electrical component-substrate 122 described with reference to FIG. 6, the electronic circuit kit electric short portion 126 is inserted and combined in the electric short combination hole 124, the electronic circuit kit electric short portion 126 is electrically connected to the electrical elements using the pad lead 125, can be perforated in a downward direction from a lower case 128 into an electric short hole 127 formed to correspond to the electric short combination hole 124.

An upper case 129 having a cap (∩) shape is inserted and combined in the substrate 122, electrical elements and the lower case 128 in a downward direction so that the substrate 122 and the electrical elements can be hidden and embedded. Thus, the electrical components for an electronic circuit study kit are configured.

Here, the present invention provides a combining means of a case having various shapes to the lower case 128 and the upper case 129 so that a solid combination state or combination state easy for attachment or detachment of the upper case 129 and the lower case 128 can be kept.

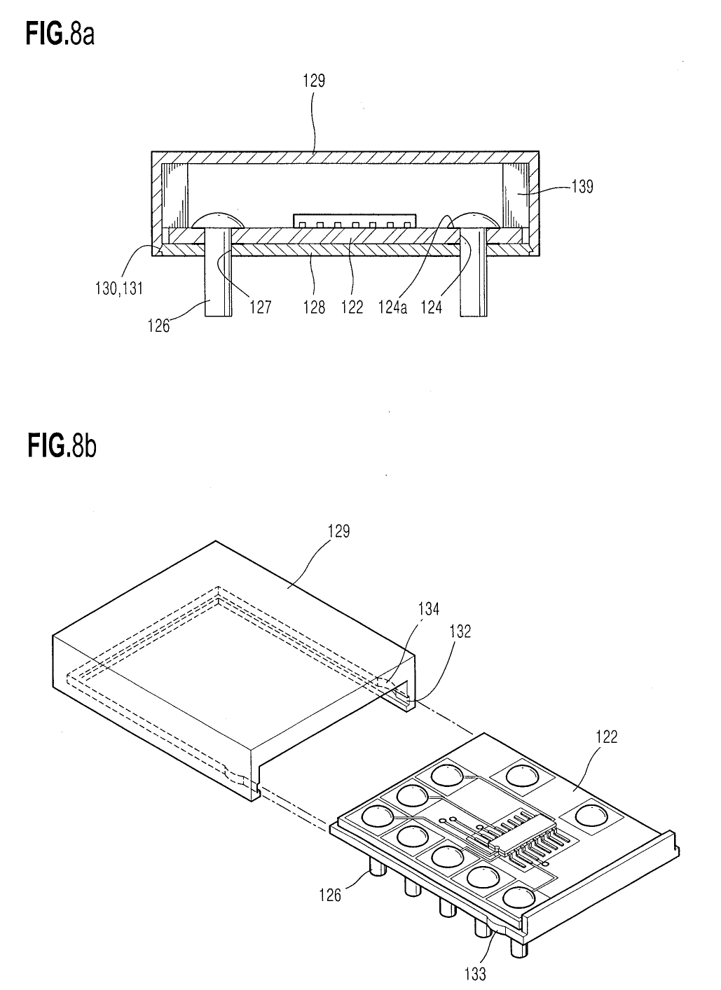

According to an embodiment of the above-described combining means of a case, as illustrated in FIG. 8A, a plurality of hooks 130 are formed on an outer end of the lower case 128, hook grooves 131 are formed on an inner side lower portion of the upper case 129 corresponding to the hooks 130 so that the upper case 129 can be inserted in a downward direction and simultaneously, the hooks 130 are inserted in the hook grooves 131 and a combination force can be kept.

Here, the hooks 130 may be formed in an inner side surface of the upper case 129 and the hook grooves 131 may be formed in an outer end of the upper case 128.

According to another embodiment of the combining means of a case, as illustrated in FIG. 8B, guide grooves 132 are formed in a lengthwise direction in both lower inner side surfaces of the upper case 129, and both ends of the lower case 128 are guided and inserted in the guide grooves 132.

Here, a fixing protrusion 133 is formed on both ends of the lower case 128 to protrude therefrom, and a fixing groove 134 is formed in a predetermined position of the guide groove 132 corresponding to the fixing protrusion 133 in the state where the lower case 128 is completely inserted along the guide groove 132 so that the lower case 128 guided and inserted in the guide groove 132 can be kept in a fixed state.

According to another embodiment of the combining means of a case, as illustrated in FIG. 8C, a plurality of fourth screw holes 135 are formed in a bottom surface of the upper case 129 to protrude therefrom in a downward direction, a fourth through hole 136 is formed in the lower case 128 to correspond to the fourth screw hole 135, and then, a third fixing screw 137 is performed into the fourth through hole 136 so that the third fixing screw 137 can be screw-coupled to the fourth screw hole 135 and the upper case 129 and the lower case 128 can be combined with each other.

Furthermore, it is preferable that a pressing portion 139 is formed on an inner bottom surface of the upper case 129, as illustrated in FIGS. 7, 8A, and 8C so that the pressing portion 139 can press the substrate 122 in a downward direction and fix it.

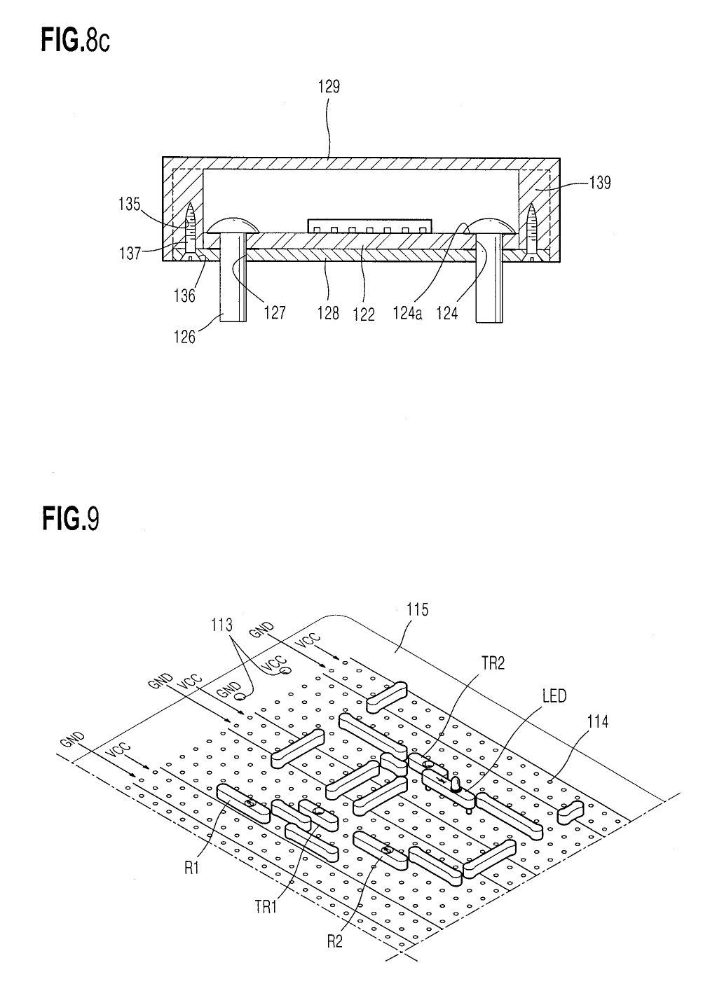

Operations and utility examples of the breadboard for an electronic circuit study kit and the electrical components for an electronic circuit study kit according to the present invention will now be described with reference to FIG. 9.

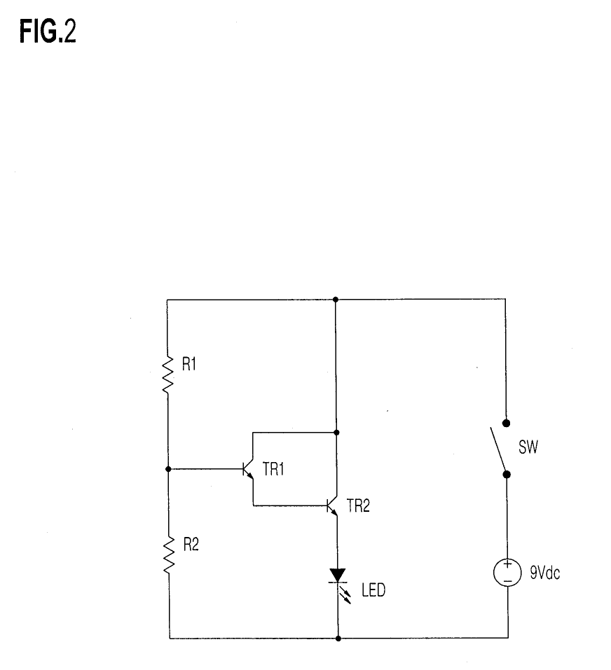

FIG. 9 illustrates the state where the circuit diagram of FIG. 2 is implemented as a breadboard for an electronic circuit study kit and electrical components for an electronic circuit study kit according to the present invention.

The circuit illustrated in FIG. 2 may be comprised of TR1, TR2, R1, R2, SW, and LED.

In an upper portion of the breadboard for an electronic circuit study kit according to the present invention, electrical components according to the present invention are electric shorted and combined with the electronic circuit kit electric short portion 126.

Here, as illustrated in FIGS. 6 and 7, electrical components comprised of 74LS00 and electrical components comprised of TR of FIG. 9 are different from each other in the positions and arrangement of the electric short connection hole 123 and the electric short combination hole 124. However, the electrical components comprised of 74LS00 and the electrical components comprised of TR of FIG. 9 belong to the scope of the invention in that the electric short connection hole 123, the electric short combination hole 124 and the pad lead 125 cannot be commonly excluded from their elements in order to configure different electrical elements using electrical components for an electronic circuit kit.

Furthermore, since various electrical elements should be configured using electrical components for an electronic circuit kit, the shape and arrangement of each of the electrical elements may be slightly different. Thus, the present invention is not limited to this.

That is, as illustrated in FIG. 9, each of electrical components comprised of TR and electrical components comprised of R includes the electric short connection hole 123, the electric short combination hole 124, the pad lead 125, and the electronic circuit kit electric short portion 126, which are essential elements. Thus, even though the electrical components comprised of TR and the electrical components comprised of R are electrical components for an electronic circuit kit having different electrical elements, they belong to the scope of the invention.

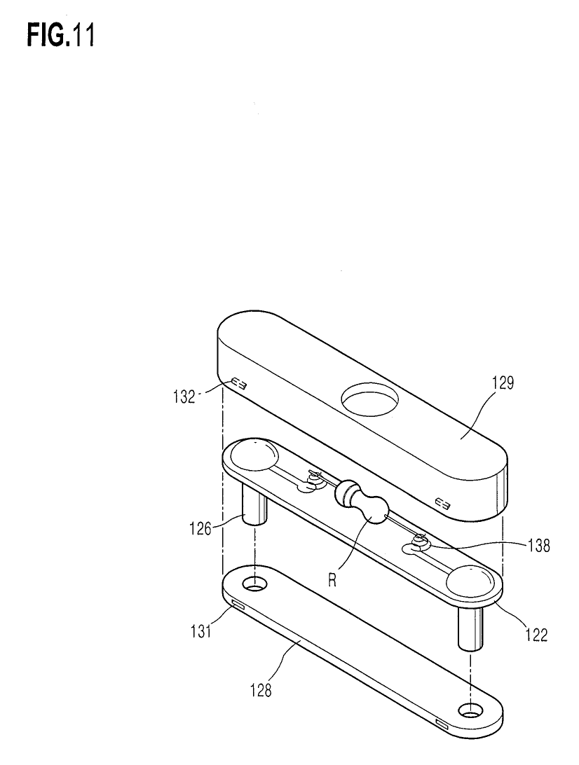

According to circumstances, when a resistor R is comprised of electronic components, as illustrated in FIG. 11, an auxiliary connection tool such as a combination spring 138 is installed in the electric short connection hole 123 of the substrate 122 and both ends of the resistor R are simply combined with the combination spring 138 so that combination and separation can be easily performed. However, elements including the additional auxiliary means also belong to electrical components for an electronic circuit kit of the present invention.

In order to configure the circuit illustrated in FIG. 2, after electrical elements TR1, TR2, LED, R1, and R2 are arranged according to the arrangement as the circuit diagram, as illustrated in FIG. 9, the electronic circuit kit short portion 126 is inserted and combined in a circuit connection hole 114 to be electric shorted to one of the power pad 101 and the ground pad 102 and SW is arranged in the same way so that the circuit can be simply configured.

Here, in the electrical elements TR1, TR2, LED, R1, and R2, like that an input terminal, an output terminal, and a logic symbol of an NAND gate of 74LS00 are indicated on the surface of the upper case 129 in FIG. 7, the magnitude of resistance is indicted on a resistor, and directions e, c, and b (standing for emitter, collector, and base) are indicated on TR so that electrical components can be easily identified and electric short works of input and output terminals can be easily performed.

### INDUSTRIAL APPLICABILITY

According to the present invention, when an electronic circuit is configured for study or test, electric short combination between electrical elements is performed through magnetic force attachment with a base by inserting and combining an electronic circuit kit electric short portion in a circuit connection hole such that a soldering work is excluded. In addition, since the circuit is configured in the state where the electrical elements are combined with electrical components for an electronic circuit kit, problems about damages of terminal pins of the electrical components are solved such that the life span of a product is guaranteed. In addition, logic symbols are indicated on the upper case of the electrical components for an electronic circuit such that the operation of an electronic circuit is easily understood and study and test efficiency is improved and a waste of resources is minimized.

What is claimed is:

1. A breadboard for an electronic circuit study kit, the breadboard comprising:
an interconnection sheet in which a plurality of power pads for electric short and a plurality of ground pads which are adjacent to one another, are formed to be spaced apart from one another from one side direction to the other side direction on a plane, the power pads and the ground pads are connected to power terminal pads and ground terminal pads which are formed in predetermined positions of an upper surface of the interconnection sheet, respectively, a plurality of interconnection pads are formed between one power pad and one ground pad which are adjacent to each other from another power pad and another ground pad which are adjacent to each other, to be spaced apart from one another in a predetermined pattern, the interconnection sheet being formed of one of a thin plate and a film sheet made of an insulating material;
a base combined with a lower portion of the interconnection sheet and formed of a metallic material to a predetermined width so that an electronic circuit kit can be attached to the base by a magnetic force; and
a combining means of an interconnection sheet for combining the interconnection sheet with the base.

2. The breadboard of claim 1, wherein the combining means of the interconnection sheet comprises:
a plurality of combining holes perforated in predetermined positions of the interconnection sheet;
a plurality of first screw holes formed in predetermined positions of the base corresponding to the combining holes; and
a first fixing screw perforated into the combining holes and screw-coupled to the first screw holes.

3. The breadboard of claim 2, further comprising an insulating plate disposed on a lower portion of the base and formed of an insulating material in which a second screw hole is formed so that the second screw hole can be combined with a first fixing screw that is screw-coupled to a first screw hole and protrudes.

4. A breadboard for an electronic circuit study kit, the breadboard comprising:
a base formed of a metallic material to a predetermined width so that an electronic circuit kit can be attached to the base by a magnetic force;
an interconnection sheet which is disposed on an upper portion of the base and in which a plurality of power pads for electric short and a plurality of ground pads which are adjacent to one another on its upper surface, are formed to be spaced apart from one another from one side direction to the other side direction on a plane, the power pads and the ground pads are connected to power terminal pads and ground terminal pads which are formed in predetermined positions of an upper surface of the interconnection sheet, respectively, a plurality of interconnection pads are formed between one power pad and one ground pad which are adjacent to each other from another power pad and another ground pad which are adjacent to each other, to be spaced apart from one another in a predetermined pattern, the interconnection sheet being formed of one of a thin plate and a film sheet made of an insulating material;
a circuit board which is disposed on an upper portion of the interconnection sheet and in which terminal holes are respectively formed in corresponding positions of the power terminal pads and the ground terminal pads of the interconnection sheet and a plurality of circuit connection holes are perforated by a predetermined distance so that the circuit connection holes can be located on vertical upper portions of the power pads, the ground pads and the interconnection pads of the interconnection sheet;
an insulating plate disposed on a lower portion of the base and formed of an insulating material; and
a combining means of the circuit board allowing the base to be combined with an upper portion of the insulating plate, the interconnection sheet to be combined with an upper portion of the base and the circuit board to be disposed and fixed on an upper portion of the interconnection sheet.

5. The breadboard of claim 4, wherein the combining means of the circuit board comprises:
a plurality of first through holes formed in the insulating plate;
a plurality of second through holes formed in the base to correspond to the first through holes;
a plurality of third through holes formed in the base to correspond to the second through holes;
a third screw hole formed to protrude from a bottom surface of the circuit board to correspond to the third through holes; and
a second fixing screw perforating the first through holes, the second through holes, and the third through holes and screw-coupled to the third screw hole.

6. Electrical components for an electronic circuit study kit, the electrical components comprising:
electric short connection holes which are perforated in an upper portion of a substrate in an arrangement pattern corresponding to terminal pin arrangement so that terminal pins of a predetermined electrical element can be inserted and combined in the electric short connection holes and in which a pad for electric short is formed on at least one of upper and lower ends of the electric short connection holes;
electric short combination holes which are perforated to a number corresponding to the number of electric short connection holes in at least one of frames of an upper surface of the substrate and in which a pad for electric short is formed on at least one of upper and lower ends of the electric short combination holes;
pad leads for electric short which are connected to a pad of the electric short connection hole and a pad of the electric short combination hole, respectively, so that the pad of the electric short connection hole and the pad of the electric short combination hole can correspond to each other and can be electric shorted and which are formed on at least one of an upper portion and a lower portion of the substrate; and
an electronic circuit kit electric short portion inserted and combined to be perforated in the electric short combination holes and formed to a predetermined length having a magnetic force.

7. Electrical components for an electronic circuit study kit, the electrical components comprising:
electric short connection holes which are perforated in an upper portion of a substrate in an arrangement pattern corresponding to terminal pin arrangement so that terminal pins of a predetermined electrical element can be inserted and combined in the electric short connection holes and in which a pad for electric short is formed on at least one of upper and lower ends of the electric short connection holes;
electric short combination holes which are perforated to a number corresponding to the number of electric short connection holes in at least one of frames of an upper surface of the substrate and in which a pad for electric short is formed on at least one of upper and lower ends of the electric short combination holes;
pad leads for electric short which are connected to a pad of the electric short connection hole and a pad of the electric short combination hole, respectively, so that the pad of the electric short connection hole and the pad of the electric short combination hole can correspond to each other and can be electric shorted and which are formed on at least one of an upper portion and a lower portion of the substrate;
an electronic circuit kit electric short portion inserted and combined to be perforated in the electric short combination holes and formed to a predetermined length having a magnetic force;
a lower case in which at least one or more electric short holes correspond to the electric short connection holes so that the electronic circuit kit electric short portion to be inserted and combined in the electric short connection holes can be perforated in a downward direction;
an upper case combined with an upper portion of the lower case and embedded in the electrical components so that the substrate can be hidden; and
a combining means of a case for combining the upper case with the lower case.

8. The electrical components of claim 7, wherein the combining means of the case comprises:
one of a hook and a hook groove formed in a predetermined position of an outer end of the lower case; and
one of a hook groove and a hook corresponding to the hook or the hook groove formed in a predetermined position of a lower inner side surface of the upper case inserted in the outer end of the lower case.

9. The electrical components of claim 7, wherein the combining means of the case comprises:
a guide groove formed on both lower inner side surfaces of the upper case in a lengthwise direction so that both ends of the lower case can be inserted and guided in the guide groove;
a fixing protrusion protruding in a predetermined position of both ends of the lower case; and
a fixing groove formed in the guide groove to correspond to the fixing protrusion.

10. The electrical components of claim 7, wherein the combining means of the case comprises:
a plurality of fourth screw holes protruding from a bottom surface of the upper case in a downward direction;
fourth through holes formed in the lower case to correspond to the fourth screw holes; and
a third fixing screw perforated into the fourth through holes and screw-coupled to the fourth screw holes.

11. The electrical components of any one of claims 7 through 10, further comprising a pressing portion protruding in a predetermined position of an inner bottom surface of the upper case toward a downward direction and pressing the substrate in the downward direction.
